(19) United States
(12) Patent Application Publication
(10) Pub. No.: US 2010/0006025 A1
(43) Pub. Date: Jan. 14, 2010

(54) EXHAUST GAS TRAP FOR SEMICONDUCTOR PROCESSES

(75) Inventor: Kazunori Furukawahara, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: ASM JAPAN K.K., Tokyo (JP)

(21) Appl. No.: 12/171,533

(22) Filed: Jul. 11, 2008

(51) Int. Cl. B05C 21/00

(52) U.S. Cl. 118/61; 29/426.1

(57) ABSTRACT

An exhaust gas trap for semiconductor processes includes: a trap body having an inlet port and an outlet port; an inlet shut-off valve provided at the inlet port; and an outlet shut-off valve provided at the outlet port. The trap body, inlet and outlet valves are integrated and can be removed together for replacement on refreshing of the trap.

### BACKGROUND OF THE INVENTION

1. Field of the Invention

The present invention generally relates to an exhaust gas trap for semiconductor processes.

2. Description of the Related Art

In a semiconductor processing apparatus, byproducts are generated during semiconductor processes in a reaction chamber, depending on the type of gas introduced into the reaction chamber. The byproducts are discharged from the reaction chamber while discharging an exhaust gas from the chamber using a vacuum pump through an exhaust port. If a process generates a large amount of byproducts, the vacuum pump and a pipe connecting the reaction chamber and the vacuum pump are likely to be clogged when an operation time is extended. In order to prevent the clogging of the vacuum pump and the pipe, an exhaust gas trap is provided upstream of the vacuum pump and downstream of the reaction chamber. The byproducts pass through the trap and are removed from the exhaust flow upstream of the vacuum pump.

FIG. 1 is a schematic view of a conventional semiconductor processing apparatus. A trap 3 is provided between a reaction chamber 2 and a vacuum pump 1 in an exhaust gas passage 4. In the exhaust gas passage 4, an open-close valve 5 and a throttle valve 6 are provided between the reaction chamber 2 and the trap 3.

The trap 3 has an inlet port 7 and an outlet port 8 at which the trap is replaceable. When the trap is replaced, the interior of the trap is exposed to the atmosphere, causing the byproducts trapped in the trap to react with oxygen in the atmosphere, discharging the gaseous byproducts inside the trap, and/or releasing deposits of the byproducts from the trap to the atmosphere. These discharged byproducts and reaction products are often hazardous.

### SUMMARY OF THE INVENTION

Consequently, in an aspect wherein one or more of the above problems can be solved, the disclosed embodiments provide an exhaust gas trap for semiconductor processes, comprising: (i) a trap body having an inlet port and an outlet port; (ii) an inlet shut-off valve provided at the inlet port; and (iii) an outlet shut-off valve provided at the outlet port.

The above aspect further includes, but is not limited to, the following embodiments:

In an embodiment, the inlet shut-off valve may be externally and gas-tightly attached to the inlet port, and the outlet shut-off valve may be externally and gas-tightly attached to the outlet port, such that these valves are configured to be removable with the trap body from the semiconductor process tool. In the above, in an embodiment, each of the inlet shut-off valve and the outlet shut-off valve may comprise: (I) a cylindrical portion attached to the corresponding inlet or outlet port wherein a gas passage is formed through the cylindrical portion and the corresponding inlet or outlet port; and (II) a valve body installed inside the cylindrical portion, wherein the valve body is movable in a direction perpendicular to an axis of the cylindrical portion to close the gas passage at the corresponding inlet or outlet port. In the above, in an embodiment, the valve body may be provided with an O-ring which is in contact with an inner surface of the cylindrical portion to seal an interior of the trap at the inner surface.

In any of the foregoing embodiments, the valve body may be a flat plate wherein the O-ring is provided along an edge of the front half of the flat plate. In the above, in an embodiment, the flat plate may have an upper side and a lower side and may further have a protrusion on the lower side around a periphery of the rear half of the flat plate, said protrusion being provided with another O-ring which is in contact with an outer surface of the cylindrical portion to seal the interior of the trap body at the inner surface and the outer surface of the cylindrical portion.

In another embodiment, the valve body may be a flat plate having an upper side and a lower side, and the O-ring may be ring-shaped and provided on the lower side along the entire periphery of the flat plate, wherein the inner surface of the cylindrical portion has an annular step with which the O-ring is in contact to seal the interior of the trap. In the above, in an embodiment, the valve body may be movable in a direction of the axis of the cylindrical portion to contact the O-ring and the annular step after the valve body may move in the direction perpendicular to the axis of the cylindrical portion.

In another embodiment, each of the inlet shut-off valve and the outlet shut-off valve may comprise: (a) a seal plate placed in an interior of the trap and having an opening corresponding to an opening of the corresponding inlet or outlet port to form a gas passage through the opening of the seal plate and the opening of the corresponding inlet or outlet port, said seal plate being pivotable on a pivot between an open position and a closed position wherein when the seal plate is at the open position, the opening of the seal plate and the opening of the corresponding inlet or outlet port is aligned in an axial direction to form the gas passage, and when the seal plate is at the closed position, the opening of the seal plate is away from the opening of the corresponding inlet or outlet port to close the gas passage at the corresponding inlet or outlet port; and (b) a device for pivoting the seal plate between the open position and the closed position. In the above embodiment, since the seal plate of the shut-off valve is installed inside the trap body, it is possible to provide a trap which is capable of closing the interior of the trap body without significantly increasing the size and weight of the trap.

The above embodiment includes, but is not limited to, the following embodiments.

In an embodiment, an O-ring may be placed on an inner surface of the trap body along the opening of each of the inlet and outlet ports for sealing the interior of the trap when each seal plate is at the closed position.

In the above, since the O-ring is placed on the inner surface of the trap body, not in the gas passage, and the O-ring and the seal plate are in contact even at the open position (the seal plate is normally at the open position when the trap is in use), the O-ring is not significantly exposed to an exhaust gas containing byproducts during operation of the semiconductor or processing tool, thereby inhibiting deposition of byproducts on the O-ring and inhibiting damage to the O-ring. As a result, until the trap is replaced, the O-ring can maintain good sealing properties, and the interior of the trap body can securely be closed during the replacement process.

In the above, in an embodiment, the seal plate may be circular and the pivot may be positioned at a center of the trap body as viewed in an axial direction. In an embodiment, another O-ring may be placed on the inner surface of the trap body at a position corresponding to a periphery of each seal plate. Alternatively, the seal plate may be fan-shaped and the pivot may be positioned at a position other than a center of the trap body as viewed in a axial direction.

In any of the foregoing embodiments, the device for pivoting the seal plate may comprise: (A) a shaft having a lower end attached to the seal plate, which serves as the pivot; (B) a handle attached to an upper end of the shaft for moving the shaft in an axial direction to press the seal plate against the O-ring when the seal plate is at the opening and closed positions and to release the seal plate from the O-ring for pivoting the seal plate; (C) a lever attached to a side of the shaft for pivoting the seal plate between the open position and the closed position; and (D) a housing attached to an outer surface of the trap body for housing the shaft.

In another aspect, the disclosed embodiments provide a semiconductor processing apparatus comprising: (1) a reaction chamber for processing semiconductor substrates; (2) a vacuum pump for evacuating the reaction chamber; (3) an exhaust gas passage connecting the reaction chamber and the vacuum pump for passing an exhaust gas from the reaction chamber to the vacuum pump; and (4) any one of the foregoing exhaust gas traps provided in the exhaust gas passage downstream of the reaction chamber and upstream of the vacuum pump. In an embodiment, the exhaust gas trap may be mechanically replaceable.

In the foregoing embodiments, the inlet shut-off valve and the outlet shut-off valve can be of the same type. However, the inlet shut-off valve and the outlet shut-off valve can be of different types. Further, the inlet port and the outlet port can have different configurations.

In another aspect, a method is provided for replacing an exhaust trap on a semiconductor processing tool. The method includes closing an inlet valve upstream of the exhaust trap body and an outlet valve downstream of the exhaust trap body. The inlet valve, the outlet valve and the exhaust trap body are removed together from the semiconductor processing tool.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description of the preferred embodiments which follow.

### BRIEF DESCRIPTION OF THE DRAWINGS

These and other features of this invention will now be described with reference to the drawings of preferred embodiments which are intended to illustrate and not to limit the invention. The drawings are oversimplified for illustrative purposes and are not to scale.

FIG. 1 is a schematic view of a conventional semiconductor processing apparatus.

FIG. 2 is a schematic cross-sectional view of an exhaust gas trap according to an embodiment of the present invention.

FIG. 3A is a schematic cross-sectional view of an inlet or outlet shut-off valve of an exhaust gas trap according to another embodiment of the present invention. FIG. 3B is a schematic perspective view of a valve body of the shut-off valve of FIG. 3A as viewed from below the valve body according to an embodiment of the present invention.

FIG. 4 is a schematic cross-sectional view of an inlet or outlet shut-off valve of an exhaust gas trap according to still another embodiment of the present invention.

FIG. 5 is a schematic view of an exhaust gas trap according to another embodiment of the present invention.

FIG. 6 is a schematic view of an exhaust gas trap with a seal plate as viewed from inside the trap body according to an embodiment of the present invention.

FIG. 7 is a schematic view of an exhaust gas trap with a seal plate as viewed from inside the trap body according to another embodiment of the present invention.

FIG. 8 is a schematic partial cross-sectional view of an exhaust gas trap with a seal plate when the inlet port is open according to an embodiment of the present invention.

FIG. 9 is a schematic partial cross-sectional view of an exhaust gas trap with a seal plate when the inlet port is closed according to an embodiment of the present invention.

FIG. 10 is a schematic partial cross-sectional view of an exhaust gas trap with a seal plate when the inlet port is open according to an embodiment of the present invention.

FIG. 11 is a schematic view of an exhaust gas trap with a seal plate as viewed from inside the trap according to an embodiment of the present invention.

FIG. 12 is a schematic partial cross-sectional view of an exhaust gas trap with a seal plate and a device for pivoting the seal plate according to an embodiment of the present invention.

FIG. 13 is a schematic view of a device for pivoting a seal plate according to an embodiment of the present invention.

### DETAILED DESCRIPTION OF THE PREFERRED EMBODIMENT

The present invention will be explained in detail with reference to preferred embodiments and drawings which are not intended to limit the present invention.

FIG. 2 is a schematic cross sectional view of an exhaust gas trap according to an embodiment of the present invention. In this embodiment, an inlet shut-off valve 21 is externally and gas-tightly attached to an inlet port 24, and an outlet shut-off valve 21′ is externally and gas-tightly attached to an outlet port 24′. When replacing the trap, a trap body 25, the inlet shut-off valve 21, and the outlet shut-off valve 21′ are integrally removed as one unit after closing the inlet and outlet shut-off valves 21, 21′, thereby sealing the interior of the trap body 25. The inlet shut-off valve 21 may be joined to the inlet port 24 using screws with an O-ring. The outer shut-off valve 21′ may be joined to the outlet port 24′ in the same manner.

In the illustrated embodiment, each of the inlet shut-off valve 21 and the outlet shut-off valve 21′ comprises: (I) a cylindrical portion 26, 26′ attached to the corresponding inlet or outlet port 24, 24′ wherein a gas passage 27, 27′ is formed through and along an axis of the cylindrical portion 26, 26′ and the corresponding inlet or outlet port 24, 24′; and (II) a valve body 28, 28′ installed at the cylindrical portion 26, 26′, wherein the valve body 28, 28′ is movable in a direction perpendicular to the axis of the cylindrical portion 26, 26′ by using a handle 19, 19′ to close the gas passage 27, 27′ at the corresponding inlet or outlet port 24, 24′. The rotation of the handle 19, 19′, which can be manually operated is converted to back and forth movement of the valve body 28, 28′. In the above, the valve body 28, 28′ is provided with an O-ring 22, 22′ or other sealing element which in the closed position is in contact with an inner sealing surface 23, 23′ of the cylindrical portion 26, 26′ to seal the interior of the trap body 25 at the inner sealing surface 23, 23′. The valve body 28, 28′ is isolated from the outside, and a bellows 29, 29′ (or alternatively an O-ring provided on a shaft) is used.

The cylindrical portion 26, 26′ of each of the inlet and outlet valves 24, 24′ is configured to be readily detachable from upstream piping (leading to the reaction chamber) and downstream piping (leading to the pump), respectively. Thus, the valves 21, 21′ and trap body 25 can be integrally removed together after closing the valves.

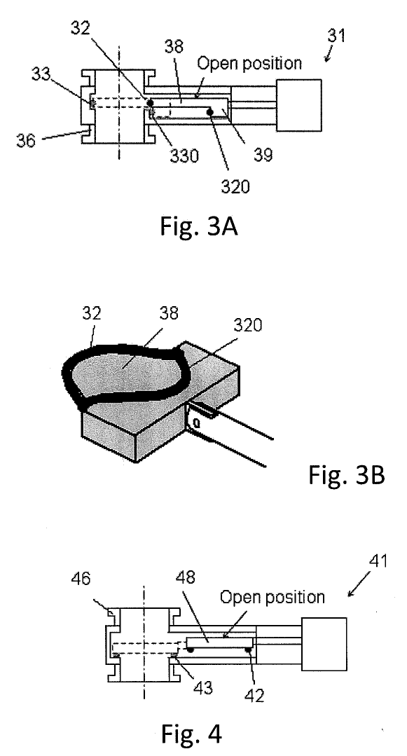

FIG. 3A is a schematic cross sectional view of an inlet or outlet shut-off valve 31 integrally connected to an exhaust gas trap body (not shown) according to another embodiment of the present invention. In this embodiment, a valve body 38 may be a flat plate wherein an O-ring 32 or other sealing element is provided along an edge of the front half of the flat plate 38. In the above, the flat plate 38 has an upper side and a lower side and further has a protrusion 39 on the lower side around a periphery of the rear half of the flat plate 38. The protrusion 39 is provided with another O-ring 320 or other sealing element which is in contact with an outer sealing surface 330 of the cylindrical portion 36 to seal the interior of the trap body at the inner sealing surface 33 and the outer sealing surface 330 of the cylindrical portion 36. FIG. 3B is a schematic prospective view of the valve body 38 as viewed from below the valve body 38 according to an embodiment of the present invention. The O-ring 32 and the O-ring 320 are continuous to be sealed at the seal surfaces of the inner surface and the outer surface of the cylindrical portion 36. The seal surfaces are shaped (e.g., recessed) so that the O-rings can fit therein. Incidentally, a bellows or O-ring (not shown) is used as is the bellows 29 in FIG. 2.

FIG. 4 is a schematic cross sectional view of an inlet or outlet shut-off valve 41 of an exhaust gas trap according to still another embodiment of the present invention. In this embodiment, a valve body 48 is a flat plate having an upper side and a lower side, and an O-ring 42 or other sealing element is ring-shaped and provided on the lower side along the entire periphery of the flat plate 48, wherein an inner surface of the cylindrical portion 46 has an annular step 43 with which the O-ring 42 is in contact to seal the interior of the trap body. In the above, the valve body 48 is movable in a direction of the axis of the cylindrical portion 46 to contact the O-ring 42 and the annular step 43 after the valve body 48 moves in the direction perpendicular to the axis of the cylindrical portion 46. Incidentally, a bellows or O-ring (not shown) is used as is the bellows in FIG. 2.

In the above embodiments, the valve body moves (at least partially) in the direction perpendicular to the axis of the cylindrical portion and in a direction so as to press the O-ring against the sealing surface of the cylindrical portion, thereby closing the gas passage or sealing the interior of the trap body. The valve body shown in FIGS. 2 and 3 indicates one-axis movement whereas the valve body shown in FIG. 4 indicates two-axis movement. In the above embodiments, when the trap is replaced, the interior of the trap can be securely closed prior to integral removal of the trap and valves. However, when the trap is in use, the gas passage is open, i.e., the valve body is at a retracted position and the O-ring and the sealing surface are exposed to the exhaust gas including byproducts. As a result, the O-ring and the sealing surface could be damaged or degraded by the time the trap is replaced, and even when the shut-off valves are closed, a tight and secured seal may not be realized. The embodiments explained below can solve at least the above problem.

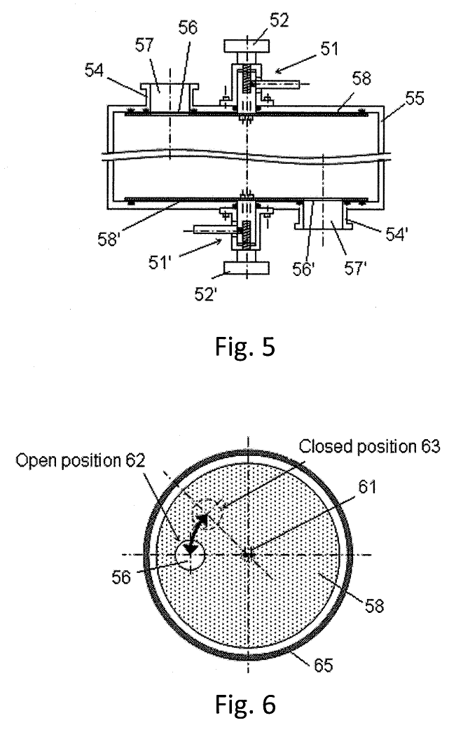

FIG. 5 is a schematic view of an integrally removable exhaust gas trap with a trap body 55, inlet valve 51 and outlet valve 51′, according to another embodiment of the present invention. In this embodiment, each of an inlet shut-off valve 51 and an outlet shut-off valve 51′ comprises: (a) a seal plate 58, 58′ placed in an interior of the trap body 55 and having an opening 56, 56′ in the plate corresponding to an opening of the corresponding inlet or outlet port 54, 54′ to form a gas passage 57, 57′ through the opening 56, 56′ of the seal plate 58, 58′ and the opening of the corresponding inlet or outlet port 54, 54′.

FIG. 6 is a schematic view of the exhaust gas trap with the seal plate 58 as viewed from inside the trap body according to an embodiment of the present invention. In this embodiment, the seal plate 58 is pivotable on a pivot 61 between an open position 62 and a closed position 63. When the seal plate 58 is at the open position 62, the opening 56 of the seal plate 58 and the opening of the corresponding inlet or outlet port 54, 54′ is aligned in an axial direction to form the gas passage 57 (FIG. 5), and when the seal plate 58 is at the closed position 63, the opening 56 of the seal plate 58 is away from the opening of the corresponding inlet or outlet port to close the gas passage 57 at the corresponding inlet or outlet port 54, 54′; and (b) a device 52 (FIG. 5) for pivoting the seal plate 58 between the open position 62 and the closed position 63. In the above embodiment, since the seal plate 58 of the shut-off valve 51 is installed inside the trap body 55, it is possible to provide a trap which is capable of closing the interior of the trap body without significantly increasing the size and weight of the trap.

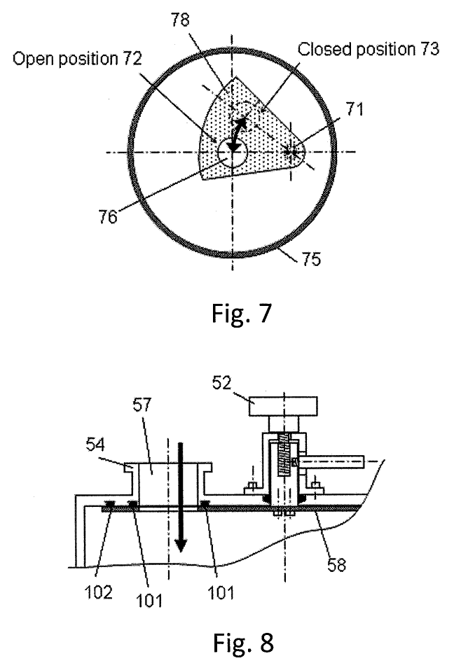

In the above, in FIG. 6, the seal plate 58 is circular and the pivot 61 is positioned at a center of the trap body 65 as viewed in an axial direction. Alternatively, in FIG. 7, a seal plate 78 for an integrated trap body 75 with inlet and outlet valves is fan-shaped and a pivot 71 can be positioned at a position other than a center of the trap body 75 as viewed in an axial direction. An opening 76 of the seal plate 78 is at the center and aligned with the opening of the corresponding inlet or outlet port. The seal plate 78 is pivotable between an open position 72 and a closed position 73.

The rotation angle of the seal plate between the open position and the closed position may be about 45° (typically 30° to 60°).

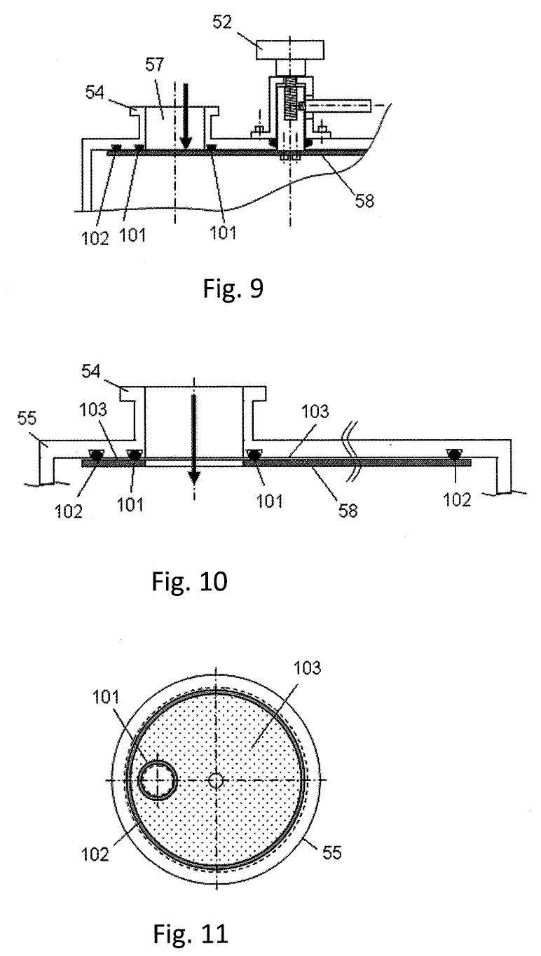

FIG. 8 is a schematic partial cross sectional view of the integrally removable exhaust gas trap with integrated inlet and outlet valves with the seal plate 58 shown in a position where the inlet port 54, such as that of FIGS. 6 or 7, is open according to an embodiment of the present invention. FIG. 9 is a schematic partial cross sectional view of the exhaust gas trap with the seal plate 58 when the inlet port 54, such as that of FIGS. 6 and 7, is closed according to an embodiment of the present invention. Open and closed positions of the integrated outlet valve can be similar to those shown for the inlet valve.

As shown in these figures, an O-ring 101 is placed on an inner surface of the trap body 55 along the opening of each of the inlet port 54 for sealing the interior of the trap body 55 when the seal plate 58 is at the closed position 63 (FIG. 9).

In the above, since the O-ring 101 is placed on the inner surface of the trap body 55, not in the gas passage 57, and the O-ring 101 and the seal plate 58 are in contact even at the open position 62 (the seal plate is normally at the open position when the trap is in use) (FIG. 8), the O-ring 101 is not significantly exposed to an exhaust gas containing byproducts, thereby inhibiting deposition of byproducts on the O-ring 101 and inhibiting damage to the O-ring 101. As a result, until the trap is replaced, the O-ring can maintain good sealing properties, and the interior of the trap body can securely be closed.

FIG. 10 is a schematic partial cross sectional view of the integrally removable exhaust gas trap 55 with integrated inlet and outlet valves, with the seal plate 58 when the inlet port 54 is open according to an embodiment of the present invention. FIG. 11 is a schematic view of the exhaust gas trap with the seal plate 58 as viewed from inside the trap body according to an embodiment of the present invention. In these drawings, another O-ring 102 is placed on the inner surface of the trap body 55 at a position corresponding to a periphery of the seal plate 58. In the above, since the two O-rings constitute the inner ring 101 and the outer ring 102, an area 103 interposed between the inner ring 101 and the outer ring 102 is formed. The area is isolated from the interior of the trap body, and thus the area including the O-rings and the sealing surface is not exposed to the interior of the trap body, thereby inhibiting deposition of byproducts, corrosion by reaction gas, and degradation and damage in the area. It will be appreciated that the integrated outlet valve (not shown) can have a similar configuration.

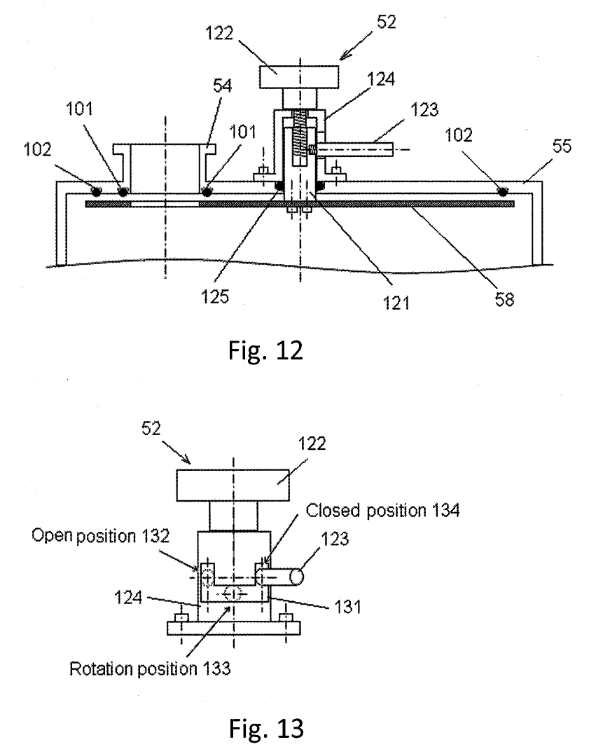

FIG. 12 is a schematic partial cross-sectional view of an integrally removable exhaust gas trap 55 with integrated inlet and outlet valves, with the seal plate 58 and the device 52 for pivoting the seal plate according to an embodiment of the present invention. In this embodiment, the device 52 for pivoting the seal plate 58 comprises: (A) a shaft 121 having a lower end attached to the seal plate 58, which serves as the pivot; (B) a handle 122 attached to an upper end of the shaft 121 for moving the shaft 121 in an axial direction to press the seal plate 58 against the O-ring 101, 102 when the seal plate 58 is at the opening and closed positions 62, 63 of FIG. 6 (an upper position or a seal position) and to release the seal plate 58 from the O-ring 101, 102 for pivoting the seal plate 58 (a lower position or a release position); (C) a lever 123 attached to a side of the shaft 121 for pivoting the seal plate 58 between the open position 62 and the closed position 63 of FIG. 6; and (D) a housing 124 attached to an outer surface of the trap body 55 for housing the shaft 121. In FIG. 12, the seal plate 58 has its opening vertically aligned with the inlet 54 at the open position but is not pressed against the O-ring 101, 102, i.e., is vertically lowered at the release position.

The seal plate 58 is fixed to the shaft 121 by welding or bolts, for example. The shaft 121 penetrates through an upper wall of the trap body 55 and vacuum-sealed using an O-ring 125. The shaft 121 moves up and down by manipulating the handle 122 which is disposed on the housing 124. The shat 121 also rotates by manipulating the lever 123 which is disposed on a side of the housing 124. Thus, by using the handle 122 and the lever 123, the seal plate 58 can easily be positioned horizontally at the open position and the closed position, and vertically at the seal position and the release position.

FIG. 13 is a schematic view of the device 52 for pivoting a seal plate according to an embodiment of the present invention. In this embodiment, a guide or slot 131 is formed in the housing 124 for guiding the lever 123 so as to control both vertical movement and rotation of the shaft in the horizontal plane. The shaft 121 and the seal plate 58 are guided to the open position and the closed position when the lever 123 is at an open position 132 and a closed position 134, respectively. The shaft 121 and the seal plate 58 rotate when the lever 123 at a rotation or “release” position 133 which is lower than the open position 132 and the closed position 134. The rotation angle of the shaft 121 and the seal plate 58 is controlled by the horizontally traveling distance of the lever 123. The movement of the lever 123 can easily and accurately be controlled by the shape of the slot 131, and by designing the slot 131, the seal plate 58 can be set to the open position and the closed position always at the respective constant positions without errors.

In the foregoing embodiments, the O-ring is used for achieving a gas tight seal. However, the O-ring can be omitted. Even if the O-ring is omitted, it is still possible to prevent solid matter from coming out from the interior of the trap body through the opening of the inlet and outlet ports during trap exchange or refresh.

In some of the foregoing embodiments, the handle 122 operates vertical movement of the shaft 121, whereas the lever 123 operates rotation of the shaft 121. However, the handle can be omitted, and the lever can operate both vertical movement and rotation, as in FIG. 13. Alternatively, the lever can be omitted, and the handle can operate both vertical movement and rotation. A protrusion, which moves along the slot, may be used instead of the lever to guide the movement of the shaft.

In the foregoing embodiments, the inlet shut-off valve and the outlet shut-off valve are of the same type. However, the inlet shut-off valve and the outlet shut-off valve can be of different types. Further, the inlet port and the outlet port can have different configurations.

The O-ring or other sealing member can be constituted by any suitable material such as FKM (Fluorine-based elastomer; such as Viton® by DuPont) or FFKM (Perfluoro-based elastomer; such as Kalrez® by DuPont or Chemraez® by Greene Tweed). In an embodiment, the “O-ring” means a ring-shaped seal or gasket or a portion or segment thereof with a generally round cross-section which is compressible to create a seal at the interface between the O-ring and another part. In an embodiment, the shape of the O-ring includes any closed loop or substantially or nearly closed loop having any shape. Further, in an embodiment, the O-ring can be any suitable seal member and need not be press-fitted in a groove but can be integrally formed with the valve body (e.g., applying an elastomer and then vulcanizing it by heat with the valve body). The seal plate can be constituted by any suitable material such as stainless steel or aluminum. The trap body can be any suitable trap of any type including any conventional gas traps for TEOS, SiH₄, or DMDMOS or any gas traps used for atomic layer deposition processes. The trapped gas type can be selected depending on the processing in the reaction chamber. In the drawings, the structure of the interior of the trap body is omitted. The interior of the trap body may include filter structures. In the foregoing embodiments, the inlet and outlet ports are disposed at an upper wall and a bottom wall of the trap body. However, they can be disposed in any suitable positions of the trap body (e.g., an upper wall and a side wall; a side wall and a side wall; a side wall and a bottom wall; both an upper wall; both a side wall; both a bottom wall). “Horizontal” and “vertical” positions or movements of valve bodies will be understood to be relative orientations.

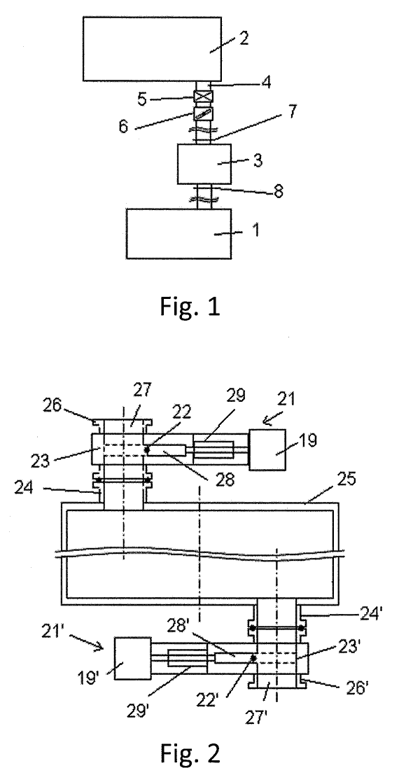

Any of the foregoing embodiments can be applied to a semiconductor processing apparatus and can replace the conventional trap 3 shown in FIG. 1. In that case, a semiconductor processing apparatus comprises: (1) a reaction chamber 2 for processing semiconductor substrates; (2) a vacuum pump 1 for evacuating the reaction chamber; (3) an exhaust gas passage 4 connecting the reaction chamber 2 and the vacuum pump 1 for passing an exhaust gas from the reaction chamber 2 to the vacuum pump 1; and (4) any one of the foregoing exhaust gas traps (in place of the trap 3) provided in the exhaust gas passage 4 downstream of the reaction chamber 2 and upstream of the vacuum pump 1. The exhaust gas trap may be mechanically replaceable, wherein the trap body and integrated inlet and outlet valves are removed together.

As explained above, at least in an embodiment of the present invention, due to the shut-off valve installed in the trap, the exposure of the interior of the trap to the atmosphere can effectively be inhibited when the trap is replaced. At least in an embodiment, due to the shut-off valve installed inside the trap body, an increase of the weight, an increase of the size, and/or an increase of the cost can be controlled. At least in an embodiment, due to the structure wherein the seal plate is pressed against the O-ring and covers the O-ring even while the trap is in use, the O-ring can be protected from deposits of byproducts and/or damage such as corrosion, so that the sealing property of the O-ring can effectively be maintained until the trap is replaced.

In the present disclosure where conditions and/or structures are not specified, the skilled artisan in the art can readily provide such conditions and/or structures, in view of the present disclosure, as a matter of routine experimentation.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. An exhaust gas trap for semiconductor processes, comprising:
a trap body having an inlet port and an outlet port;
an inlet shut-off valve provided at the inlet port; and
an outlet shut-off valve provided at the outlet port.

2. The exhaust gas trap according to claim 1, wherein the inlet shut-off valve is externally and gas-tightly attached to the inlet port, and the outlet shut-off valve is externally and gas-tightly attached to the outlet port.

3. The exhaust gas trap according to claim 2, wherein each of the inlet shut-off valve and the outlet shut-off valve comprises:
a cylindrical portion attached to the corresponding inlet or outlet port wherein a gas passage is formed through the cylindrical portion and the corresponding inlet or outlet port; and
a valve body installed at the cylindrical portion, wherein the valve body is movable in a direction perpendicular to an axis of the cylindrical portion to close the gas passage at the corresponding inlet or outlet port.

4. The exhaust gas trap according to claim 3, wherein the valve body is provided with an O-ring which is in contact with an inner surface of the cylindrical portion to seal an interior of the trap body at the inner surface.

5. The exhaust gas trap according to claim 4, wherein the valve body is a flat plate wherein the O-ring is provided along an edge of the front half of the flat plate.

6. The exhaust gas trap according to claim 5, wherein the flat plate has an upper side and a lower side and further has a protrusion on the lower side around a periphery of the rear half of the flat plate, said protrusion being provided with another O-ring which is in contact with an outer surface of the cylindrical portion to seal the interior of the trap body at the inner surface and the outer surface of the cylindrical portion.

7. The exhaust gas trap according to claim 4, wherein the valve body is a flat plate having an upper side and a lower side, and the O-ring is ring-shaped and provided on the lower side along the entire periphery of the flat plate, wherein the inner surface of the cylindrical portion has an annular step with which the O-ring is in contact to seal the interior of the trap body.

8. The exhaust gas trap according to claim 7, wherein the valve body is movable in a direction of the axis of the cylindrical portion to contact the O-ring and the annular step after the valve body moves in the direction perpendicular to the axis of the cylindrical portion.

9. The exhaust gas trap according to claim 1, wherein each of the inlet shut-off valve and the outlet shut-off valve comprises:
a seal plate placed in an interior of the trap body and having an opening corresponding to an opening of the corresponding inlet or outlet port to form a gas passage through the opening of the seal plate and the opening of the corresponding inlet or outlet port, said seal plate being pivotable on a pivot between an open position and a closed position wherein, when the seal plate is at the open position, the opening of the seal plate and the opening of the corresponding inlet or outlet port is aligned in an axial direction to form the gas passage, and when the seal plate is at the closed position, the opening of the seal plate is away from the opening of the corresponding inlet or outlet port to close the gas passage at the corresponding inlet or outlet port; and
a device for pivoting the seal plate between the open position and the closed position.

10. The exhaust gas trap according to claim 9, wherein an O-ring is placed on an inner surface of the trap body along the opening of each of the inlet and outlet ports for sealing the interior of the trap body when each seal plate is at the closed position.

11. The exhaust gas trap according to claim 10, wherein the seal plate is circular and the pivot is positioned at a center of the trap body as viewed in an axial direction.

12. The exhaust gas trap according to claim 11, wherein another O-ring is placed on the inner surface of the trap body at a position corresponding to a periphery of each seal plate.

13. The exhaust gas trap according to claim 10, wherein the seal plate is fan-shaped and the pivot is positioned at a position other than a center of the trap body as viewed in an axial direction.

14. The exhaust gas trap according to claim 10, wherein the device for pivoting the seal plate comprises:
a shaft having a lower end attached to the seal plate, which serves as the pivot;
a handle attached to an upper end of the shaft for moving the shaft in an axial direction to press the seal plate against the O-ring when the seal plate is at the opening and closed positions and to release the seal plate from the O-ring for pivoting the seal plate;
a lever attached to a side of the shaft for pivoting the seal plate between the open position and the closed position; and
a housing attached to an outer surface of the trap body for housing the shaft.

15. A semiconductor processing apparatus comprising:
a reaction chamber for processing semiconductor substrates;
a vacuum pump for evacuating the reaction chamber;
an exhaust gas passage connecting the reaction chamber and the vacuum pump for passing an exhaust gas from the reaction chamber to the vacuum pump; and
the exhaust gas trap provided in the exhaust gas passage downstream of the reaction chamber and upstream of the vacuum pump, the exhaust gas trap including:
a trap body having an inlet port and an outlet port;
an inlet shut-off valve provided at the inlet port; and
an outlet shut-off valve provided at the outlet port.

16. The semiconductor processing apparatus according to claim 15, wherein the exhaust gas trap is mechanically replaceable.

17. The semiconductor processing apparatus according to claim 15, wherein the trap body, inlet shut-off valve and outlet shut-off valve are integrally removable from the exhaust passage.

18. A method of replacing an exhaust trap on a semiconductor processing tool, comprising:
closing an inlet valve upstream of an exhaust trap body;
closing an outlet valve downstream of the exhaust trap body; and
removing the inlet valve, the outlet valve and the exhaust trap body together from the semiconductor processing tool.
